(19) United States
(12) Patent Application Publication
(10) Pub. No.: US 2025/0005016 A1
(43) Pub. Date: Jan. 2, 2025

(54) USING CHUNKS OF DATA TO STORE STREAMING DATA AT A CLOUD SERVICE PROVIDER

(71) Applicant: Dell Products, L.P., Round Rock, TX (US)

(72) Inventors: Yurun Wu, Shanghai (CN); Jiang Cao, Shanghai (CN); Kalyan Gunda, Bangalore (IN); Lu Lei, Shanghai (CN)

(21) Appl. No.: 18/345,045

(22) Filed: Jun. 30, 2023

(51) Int. Cl. G06F 16/23

(52) U.S. Cl. CPC G06F 16/2379

(57) ABSTRACT

The technologies described herein are generally directed toward using chunks of data to store streaming data at a cloud service provider. In an embodiment, a method can include, based on first application data, initiating a cloud storage transaction, corresponding to a chunk of data. The method can further include communicating a first data part of the chunk to the cloud storage server. Further, the method can include, based on second application data, communicating a second data part of the chunk to the cloud storage server, with the first data part and the second data part being, as generated, stored in a commit buffer, and with a first chunk offset and a second chunk offset being stored in metadata. The method can further include, based on a size of the chunk, communicating a commit signal to commit the cloud storage transaction.

### BACKGROUND

Modern data storage systems can facilitate the storage and manipulation of data streams. Different approaches can be used to improve the performance and scalability of the data storage, retrieval, and manipulation of data streams operations. In some circumstances different approaches can be difficult to scale. For storing streams, this can be significant because, as storage of continuous and unbounded data, storage of a stream can require the regular addition of additional resources to storage systems.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can include a processor and a memory that stores executable instructions that, when executed by the processor, facilitate performance of operations. The instructions can include an instruction to, based on first application data, initiate a cloud storage transaction with a cloud storage server that enables services associated with a cloud service provider, with the cloud storage transaction corresponding to a chunk of data. The instructions can further include an instruction to, based on the first application data, facilitate communicating a first data part of the chunk to the cloud storage server. The instructions can further include an instruction to, based on second application data, facilitate communicating a second data part of the chunk to the cloud storage server, with the first data part and the second data part being, as generated, stored in a commit buffer, and with a first chunk offset of the first data part and a second chunk offset of the second data part being stored in metadata. The instructions can further include an instruction to, based on a size of the chunk, facilitate communicating a commit signal to commit the cloud storage transaction.

In additional or alternative embodiments, the instructions can further include additional instructions to perform additional actions to store the data object, resulting in a stored data object. In additional or alternative embodiments, the additional actions can further include, after the multipart transaction is committed, identifying a data object offset value that corresponds to the second block of data stored in the data object. In additional or alternative embodiments, the additional actions can further include, based on the data object offset value, determining a storage location of the second block of data within the data object. In additional or alternative embodiments, the additional actions can further include, identifying the data object offset by receiving the metadata stored by the stream storage equipment that implicates the data object offset value, and based on the metadata, identifying the data object offset value.

In additional or alternative embodiments, the additional actions can further include, grouping the first block of data and the second block of data into a storage group that corresponds to the multipart transaction, with the metadata including group offset information that corresponds to group offset data for the first block of data and the second block of data allocated to the multipart transaction. In additional or alternative embodiments, identifying the data object offset value based on the metadata can include mapping the group offset data corresponding to the second block of data to the data object offset value. In additional or alternative embodiments, the first block of data and the second block of data include a stream of application data.

An example method can comprise, based on first application data, initiating a cloud storage transaction with a cloud storage server that enables services associated with a cloud service provider, with the cloud storage transaction corresponding to a chunk of data. Further, the method can include, based on the first application data, facilitating communicating a first data part of the chunk to the cloud storage server. Further, the method can include, based on second application data, facilitating communicating a second data part of the chunk to the cloud storage server, with the first data part and the second data part being, as generated, stored in a commit buffer, and with a first chunk offset of the first data part and a second chunk offset of the second data part being stored in metadata. Further, the method can include, based on a size of the chunk, facilitating communicating a commit signal to commit the cloud storage transaction.

In additional or alternative embodiments, the commit buffer can be comprised in local, volatile storage. In additional or alternative embodiments, the commit signal can be communicated to result in the first data part and the second data part being combined, resulting in combined data parts, and the combined data parts being stored as a data object in the cloud storage server, resulting in a stored data object. In additional or alternative embodiments, after the commit signal is communicated, receiving a request to retrieve the second application data can be facilitated. In additional or alternative embodiments, based on the metadata, the stored data object can be identified to contain the second application data. In additional or alternative embodiments, based on the second chunk offset, an object offset corresponding to the second application data stored in the stored data object can be identified. In additional or alternative embodiments, the second application data from the stored data object can be retrieved, with the second application data being identified for retrieval based on the object offset of the second application data. In additional or alternative embodiments, the stored data object may be immutable.

In additional or alternative embodiments, the size of the chunk was selected based on a data retrieval constraint of an application that generated the first application data and the second application data. In additional or alternative embodiments, the first data part and the second data part can be communicated as generated without implicating local non-volatile storage. In additional or alternative embodiments, before the commit signal is communicated, facilitating, by the system, receiving a request to retrieve the second application data; and in response to receiving the request, retrieving, by the system, the second application data from the second data part stored in the commit buffer. In additional or alternative embodiments, the first data part and the second data part can include a stream of application data.

An example non-transitory computer-readable medium can comprise instructions that, in response to execution, cause a system comprising a processor to perform operations. These operations can comprise, based on first application data, an operation to initiate a cloud storage transaction with a cloud storage server that enables services associated with a cloud service provider, with the cloud storage transaction corresponding to a chunk of data. Further, the operations can include an operation to, based on the first application data, facilitate communicating a first data part of the chunk to the cloud storage server. Further, the operations can include an operation to, based on second application data, facilitate communicating a second data part of the chunk to the cloud storage server, with the first data part and the second data part being, as generated, stored in a commit buffer, and with a first chunk offset of the first data part and a second chunk offset of the second data part being stored in metadata. Further, the operations can include an operation to, based on a size of the chunk, facilitate communicating a commit signal to commit the cloud storage transaction.

In additional or alternative embodiments, instructions further include, based on a total size of the part of stream and the other part of the stream, committing the cloud storage transaction to be stored via storage equipment corresponding to the cloud service provider. In additional or alternative embodiments, the instructions can further include, receiving by the system, a request to retrieve the other part of the stream. In additional or alternative embodiments, the instructions can further include, responsive to the request, retrieving the other part of the stream from the other part stored in the part buffer. In additional or alternative embodiments, the instructions can further include, after the retrieving, sending a commit signal to commit the cloud storage transaction. In additional or alternative embodiments, the instructions can further include, the part buffer is comprised in volatile storage that is local to the stream storage device.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using chunks of data to store streaming data at a cloud service provider, in accordance with one or more embodiments.

FIG. 2 is an architecture diagram of a non-limiting example system that can facilitate using chunks of data to store streaming data at a cloud service provider, in accordance with one or more embodiments.

FIG. 3 is a non-limiting example of a data stream broken into separate data chunks for storage at a cloud storage server, in accordance with one or more embodiments.

FIG. 4 is an architecture diagram of an example system that can facilitate using chunks of data to store streaming data at a cloud service provider, in accordance with one or more embodiments.

FIG. 5 is a sequence diagram that illustrates example interactions and message exchanges over a period of time between different components of a system that can facilitate using chunks of data to store streaming data at a cloud service provider, in accordance with one or more embodiments.

FIG. 6 is a sequence diagram that illustrates example interactions and message exchanges over a period of time between different components of a system that can facilitate using chunks of data to store streaming data at a cloud service provider, in accordance with one or more embodiments.

FIG. 7 depicts a flow diagram representing example operations of an example method that can facilitate using chunks of data to store streaming data at a cloud service provider, in accordance with one or more embodiments.

FIG. 8 depicts an example system that can facilitate using chunks of data to store streaming data at a cloud service provider, in accordance with one or more embodiments.

FIG. 9 depicts an example non-transitory machine-readable medium that can include executable instructions that, when executed by a processor of a system, can facilitate using chunks of data to store streaming data at a cloud service provider, in accordance with one or more embodiments.

FIG. 10 depicts an example schematic block diagram of a computing environment with which the disclosed subject matter can interact, in accordance with one or more embodiments.

FIG. 11 illustrates an example block diagram of a computer operable to execute an embodiment of this disclosure.

### DETAILED DESCRIPTION

Generally speaking, one or more embodiments described herein can facilitate using chunks of data to store streaming data at a cloud service provider. One or more embodiments can use different approaches to using chunks of data to store streaming data at a cloud service provider.

As is understood by one having skill in the relevant art(s), given the description herein, the implementation(s) described herein are non-limiting examples, and variations to the technology can be implemented. For instance, even though many examples described herein discuss cloud storage devices, the technologies described herein can be used in many applicable circumstances, e.g., storing streams data with other types of data storage. As such, any of the embodiments, aspects, concepts, structures, functionalities, implementations and/or examples described herein are non-limiting, and the technologies described and suggested herein can be used in various ways that provide benefits and advantages to data manipulation system technology in general, both for existing technologies and technologies in this and similar areas that are yet to be developed.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally, one or more embodiments can facilitate the use of cloud storage systems for the storage and retrieval of streaming data, e.g., a continuous and unbounded data flow that can be generated by various data sources with high data volumes and velocity.

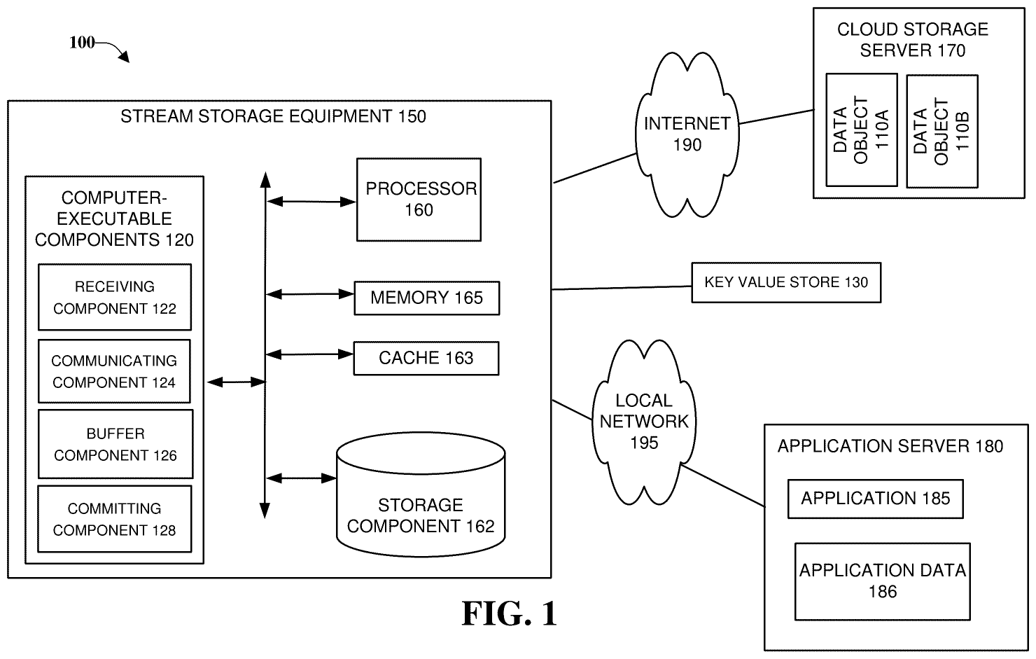

FIG. 1 is an architecture diagram of an example system 100 that can facilitate using chunks of data to store streaming data at a cloud service provider, in accordance with one or more embodiments. For purposes of brevity, description of like elements and/or processes employed in other embodiments is omitted. As depicted, system 100 includes stream storage equipment 150 connected to cloud storage server 170 via internet 190, and application server 180 via local network 195. Application server 180 includes application 185 and application data 186. Application 185 is representative of an application with data storage and retrieval requirements, and application data 186 is representative of the data utilized by application 185.

In one or more embodiments, cloud storage server 170 can include data objects 110A-B. In some implementations, cloud storage server 170 can be operated based on de facto standards for many different third-party object storage systems, e.g., systems widely adopted as the storage layer for cloud computing and data lakes. Different approaches to utilizing cloud storage systems can utilize dedicated local file systems on each node for storage, with this approach potentially limiting the capacity to rapidly scale the systems. This locally dedicated storage approach can also limit the use of data storage structures other than file systems, which in turn can limit the usage scenarios of stream storage systems. As discussed further below, to facilitate access to information store by embodiment described herein, key value store 130 can be used to persist as metadata, different offset values that identify the location of stored data.

Stream storage equipment 150 includes memory 165, processor 160, storage component 162, and cache 163. According to multiple embodiments, memory 165 of stream storage equipment 150 can store one or more computer and/or machine readable, writable, and/or executable components 120 and/or instructions. In one or more embodiments, computer-executable components 120, when executed by processor 160, can facilitate performance of operations defined by the executable component(s) and/or instruction(s). Computer executable components 120 can include receiving component 122, communicating component 124, buffering component 126, committing component 128, and other components described or suggested by different embodiments described herein, that can improve the operation of system 100 or other systems described herein.

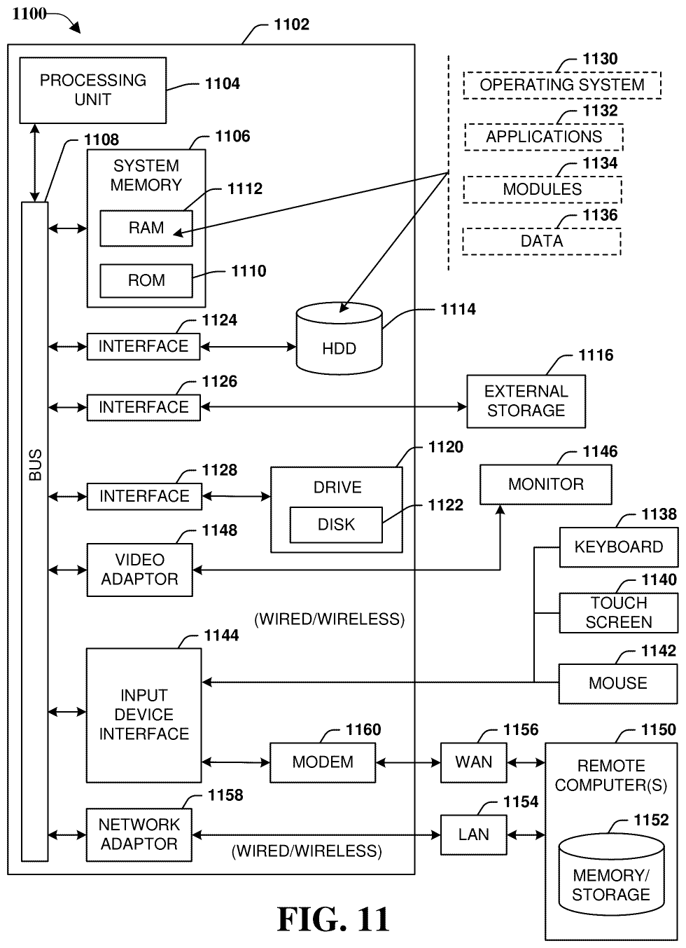

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1104 of FIG. 11. Such examples of processor 160 can be employed to implement any embodiments of the subject disclosure.

As discussed further with FIG. 11 below, local network 195 and internet 190 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1106 and FIG. 11. Such examples of memory 165 can be employed to implement any embodiments of the subject disclosure. In some embodiments, memory 165 can comprise non-volatile random-access memory (NVRAM), with different uses including journaled manipulation of storage component 162 data and the enabling of concurrent updating of some types of stored data, in accordance with one or more embodiments. In some embodiments, cache 163 can comprise volatile memory used for caching chunk data to promote visibility of transaction data as the transaction is open.

It is understood that the computer processing systems, computer-implemented methods, apparatus, and computer program products described herein employ computer hardware and/or software to solve problems that are highly technical in nature (e.g., utilizing cloud storage protocols to store potentially high-velocity unbounded data streams), that are not abstract and cannot be performed as a set of mental acts by a human. For example, a human, or even a plurality of humans, cannot efficiently handle the complex, rapid storage of streaming data according to cloud storage provider requirements.

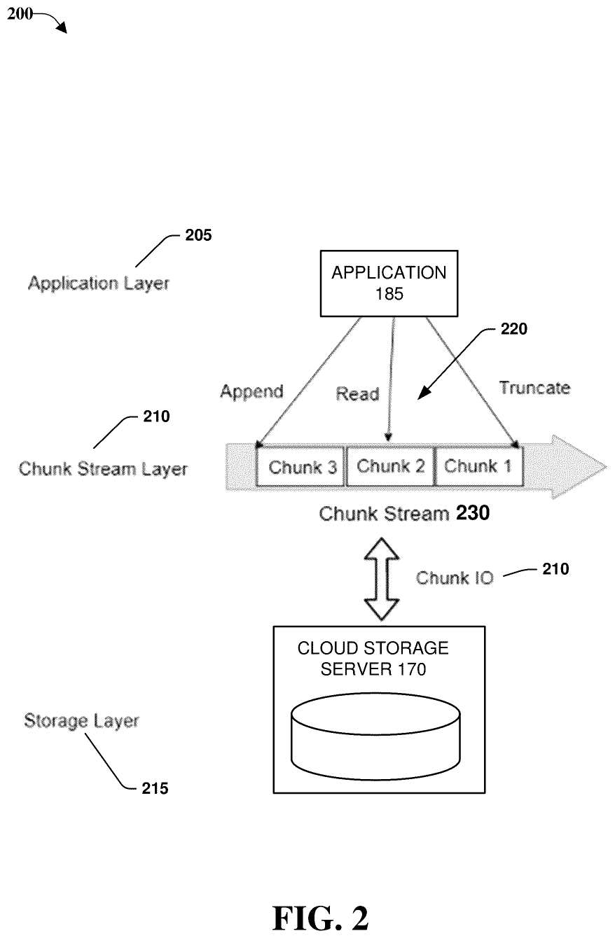

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of receiving component 122, which can in some implementations, based on first application data, initiate a cloud storage transaction with a cloud storage server that can enable services associated with a cloud service provider, with the cloud storage transaction corresponding to a chunk of data. For example, one or more embodiments can, based on first application data, initiate a cloud storage transaction with cloud storage server 170 that can enable services associated with a cloud service provider, with the cloud storage transaction corresponding to a chunk of data, e.g., discussed with FIGS. 2-6 below.

In another example, memory 165 can store executable instructions that can facilitate generation of communicating component 124, which can in some implementations, based on the first application data, facilitate communicating a first data part of the chunk to the cloud storage server. For example, one or more embodiments, communicating component 124 can, based on the first application data, facilitate communicating a first data part of the chunk to cloud storage server 170.

In another example, memory 165 can store executable instructions that can facilitate generation of buffering component 126, which in some implementations can, based on second application data, facilitate communicating a second data part of the chunk to the cloud storage server, with the first data part and the second data part being, as generated, stored in a commit buffer, and with a first chunk offset of the first data part and a second chunk offset of the second data part being stored in metadata. For example, one or more embodiments can, based on second application data, facilitate communicating a second data part of the chunk to cloud storage server 170, with the first data part and the second data part being, as generated, stored in a commit buffer, and with a first chunk offset of the first data part and a second chunk offset of the second data part being stored in metadata.

In another example, memory 165 can store executable instructions that can facilitate generation of committing component 128, which in some implementations can, based on a size of the chunk, facilitate communicating a commit signal to commit the cloud storage transaction. For example, one or more embodiments can, based on a size of the chunk, facilitate communicating a commit signal to cloud storage server 170 to commit the cloud storage transaction.

It is appreciated that the embodiments of the subject disclosure depicted in various figures disclosed herein are for illustration only, and as such, the architecture of such embodiments are not limited to the systems, devices, and/or components depicted therein. For example, in some embodiments, stream storage equipment 150 can further comprise various computer and/or computing-based elements described herein with reference to operating environment 1100 and FIG. 11. In one or more embodiments, such computer and/or computing-based elements can be used in connection with implementing one or more of the systems, devices, components, and/or computer-implemented operations shown and described in connection with FIG. 1 or other figures disclosed herein.

It should be noted that stream storage equipment 150, and other equipment discussed herein, can execute code instructions that may operate on servers or systems, remote data centers, or ‘on-box’ in individual client information handling systems, according to various embodiments herein. In some embodiments, it is understood any or all implementations of one or more embodiments described herein can operate on a plurality of computers, collectively referred to as stream storage equipment 150. For example, one or more of stream storage equipment 150, and other equipment discussed herein can all be separate subsystems running in the kernel of a computing device as well as operating on separate network equipment, e.g., as depicted in FIG. 1.

As described in some examples below, an example system that can benefit in some circumstances from the use of one or more embodiments, is a system that can facilitate storing and retrieving streaming data among networked computing devices, e.g., file storage systems and databases. In some implementations, system 100 can be a file storage system that implements storage of unbounded data streams. In different implementations, stream storage systems can benefit from increased flexibility, redundancy, security, and decreased latency, which can be provided by one or more embodiments.

Example data protection systems which can employ one or more of the approaches described with embodiments herein include, but are not limited to EMC ISILON®, an example network attached storage (NAS) platform provided by DELL EMC, Inc. Example storage array devices which can employ one or more of the approaches described with embodiments herein include, but are not limited to, POWERMAX® enterprise data storage array system provided by DELL EMC, Inc.

One or more embodiments can be relatively lightweight in terms of memory and storage cost as compared to other approaches, e.g., using a protocol associated with storing data at cloud-based storage (e.g., cloud storage server 170), and having no dependencies upon local non-volatile storage resources (e.g., storage component 162), which can result in some circumstances facilitate upscaling stream storage capacity without cost associated with additional local storage. One or more embodiments can facilitate use by a streaming service of public cloud services, e.g., cloud storage server 170. As discussed further with the descriptions of FIGS. 2-6 below, one or more embodiments can facilitate the tuning of write throughput and write latencies according to the requirements of application 185. In addition, to facilitate recovery of data, one or more embodiments can provide tail read capabilities with relatively low latency compared to other approaches.

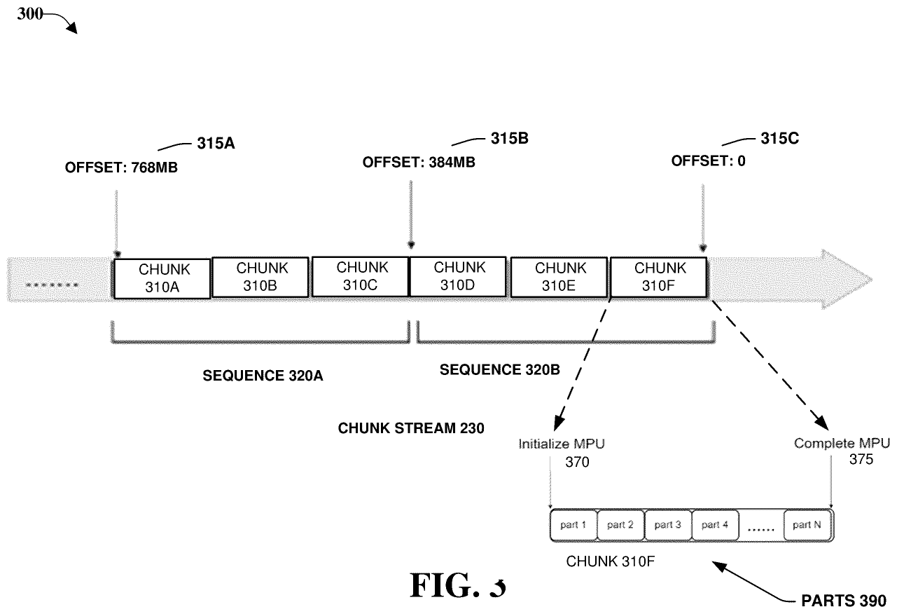

FIGS. 2 and 3 describe an example system whereby streaming data is received by stream storage equipment 150 and divided into data chunks for transmission to cloud storage server 170. FIG. 2 is an architecture diagram of an example system 200 that can facilitate using chunks of data to store streaming data at a cloud service provider, in accordance with one or more embodiments. For purposes of brevity, description of like elements and/or processes employed in other embodiments is omitted. As depicted, application layer 205 includes application 185, chunk stream layer 210 includes chunks 220 of chunk stream 230, and storage layer 215 includes cloud storage server 170.

As implemented, stream application layer 205 can support different general stream operations, e.g., append, read, and truncate as shown. For example, in one or more embodiments, application 185 can submit data to be appended to data at chunk stream layer 210, and can also submit requests to read from the data at chunk stream layer 210. In one or more embodiments, chunk stream layer 210 can provide clean abstractions of stream semantics to stream application layer 205. It also connects to underlying object storage to persist data.

As discussed further below, chunk stream layer 210 can organize chunk stream 230 data into chunks grouped sequentially within chunk sequences. In one or more embodiments, ones of data chunks 220 can cover a logical range in the chunk stream 230 to which the data chunk belongs.

FIG. 3 is a non-limiting example 300 of a data stream broken into separate data chunks for storage at a cloud storage server, in accordance with one or more embodiments. For purposes of brevity, description of like elements and/or processes employed in other embodiments is omitted.

As depicted, chunk stream 230 includes chunks 310A-C and 310D-F, grouped into sequences 320A-B respectively. In one or more embodiments, sequences 320A-B have logical start/end offsets that indicate indicating which range this sequence covers in the whole stream, e.g., sequence 320B having a range from offset 315C(0) to offset 315B (384 MB), and sequence 320A having a range from offset 315B to offset 315A (768 MB). As shown, ones of chunks 310A-F can be divided into multiple parts 390, and the collection of these parts 390 make up a multipart transaction (MPU), discussed below, e.g., initialize MPU 370 and complete MPU 375.

In one or more embodiments, the chunks in a sequence are tracked by stream storage equipment 150 by using key-value store 130, e.g., with the key used being a chunk stream name (e.g., chunk stream 320) and a sequence of this stream and a sequence within chunk stream 320, e.g., sequence 320B. In some implementations, the value corresponding to the key can include the offsets of the sequence, e.g., offset 315B-C referencing sequence 320B. In one or more embodiments, the use of the above-described chunk-sequence hierarchy can reduce the number of key/value pairs in key/value storage, as well as facilitating the locating of data chunks during a random read process. As implemented, chunk stream 320 can be a logical stream that consists of a sequence of chunks connected in order, e.g., the sequence having a head and a tail.

In one or more embodiments, the maximum number of data chunks of data stream 320 that are grouped in a sequence is configurable, e.g., one thousand (1000) chunks included in a sequence are referenced by only one (1) key value pair in metadata stored at key value store 130.

In one or more embodiments, receiving component 122 can, based on first application data, initiate a cloud storage transaction with a cloud storage server that can enable services associated with a cloud service provider, with the cloud storage transaction corresponding to a chunk of data. In an implementation, based on the request from stream storage equipment 150, cloud storage server 170 can generate a multipart transaction. In an implementation, the multipart transaction generated can be a multipart upload transaction, e.g., provided by cloud storage server 170.

In an example depicted in FIG. 3, chunk stream 320 can be processed by stream storage equipment 150 and divided into chunks of a selected size. When chunk 310F is generated from the stream input, receiving component 122 initiates a multipart transaction to process chunk 310F. e.g., initialize a multipart transaction with cloud storage server 170.

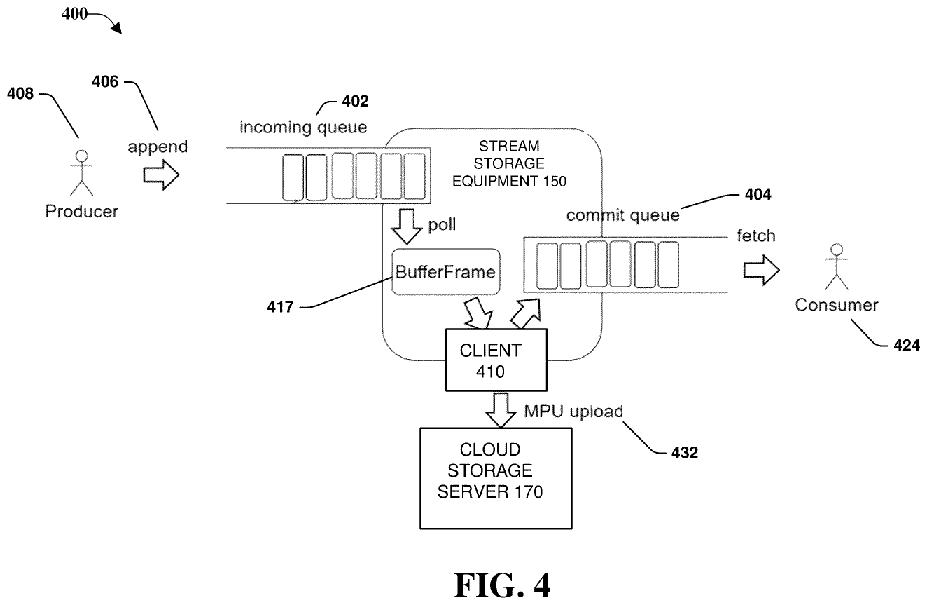

After initiating the multipart transaction, cloud storage server 170 can incrementally receive, from the stream storage equipment, a first block of data and a second block of data allocated to the multipart transaction (e.g., parts 390), with stream storage equipment 150 retaining a copy of the first block of data and the second block of data in volatile storage, e.g., cache 163 described with FIG. 4 below.

In some implementations, upon the initialization of MPU, the data chunk can be considered empty without a known length. As application data 186 is received by stream storage equipment 150, every write to chunk 310F is translated to a part of parts 390, e.g., for uploading to cloud storage server 170. As parts 390 are received, the sequence of each part can be monotonically increased upon each chunk write.

In one or more embodiments, once a condition is met, the multipart transaction can be committed by sending an instruction (e.g., by committing component 128) to cloud storage server 170. In an example, the condition used to trigger the commitment of the transaction can be the size of the chunk 310F increasing to beyond a specified size. Based on the instruction to commit the multipart transaction, the first block of data and the second block of data can be aggregated into a data object (e.g., data object 110A) that corresponds to chunk 310F. For example, after the size of data chunk 310F reaches the predefined limit (e.g., 256 MB), all of the parts that were uploaded are committed by cloud storage server 170, and the MPU transaction is completed. As implemented, chunk stream 320 can be a logical stream that consists of a sequence of chunks connected in order, e.g., the sequence having a head and a tail. Because of the metadata stored during the data chunk creation and upload process, chunk stream 320 can be read from any given valid offset between head and tail, e.g., provided by the metadata.

FIG. 4 is an architecture diagram of an example system 400 that can facilitate using chunks of data to store streaming data at a cloud service provider, in accordance with one or more embodiments. For purposes of brevity, description of like elements and/or processes employed in other embodiments is omitted. System 400 includes producer 408, incoming queue 402, stream storage equipment 150, cloud storage server 170 via client 410, commit queue 404, consumer 424. Stream storage equipment 150 can receive streamed events via incoming queue 402.

FIG. 4 depicts an example internal events data flow by embodiments of stream storage equipment 150. The incoming events append requests are buffered in incoming queue 402 in the stream storage equipment 150. Once incoming queue 402 size reaches the upload size lower limit, all events are polled out and constructed as a buffer frame. A buffer frame is the unit for an MPU upload. Once the buffer frame is uploaded, the events in that frame can be removed from memory.

In an implantation of cloud storage server 170, an MPU object may not be visible to stream storage equipment during its transaction, e.g., application 185 cannot access data that is currently in an uncommitted transaction, and consumers cannot see events written in the last uncommitted chunk until the underlying MPU is committed. In one or more embodiments, to improve the visibility of transaction data to consumers, stream storage equipment 150 can cache the uncommitted MPU parts in commit queue 204 and make the queued data visible to consumers during the pendency of the transaction. In an implementation example, when the chunk size limit is 256 MB, then the largest possible commit queue 204 size is 256 MB.

During the pendency of the transaction, consumer 424 can fetch the latest events (e.g., parts 390 of chunk 310F) in the tail of a stream retrieved directly from commit queue 204, e.g., rather than reading the data from an object. Upon a chunk rotation, namely the object related to the last chunk has been committed to cloud storage server 170, commit queue 204 can be emptied, and ready to hold events from a new uncommitted chunk.

In additional or alternative embodiments, after the multipart transaction is committed, a data object offset value can be identified that corresponds to a part of data chunk 320 stored in the data object. In additional or alternative embodiments, to locate the requested data, the data object offset value for the data can be identified and a storage location of the second block of data within the data object may be identified. In additional or alternative embodiments, the additional actions can further include, identifying the data object offset by receiving the metadata stored by the stream storage equipment that implicates the data object offset value, and based on the metadata, identifying the data object offset value.

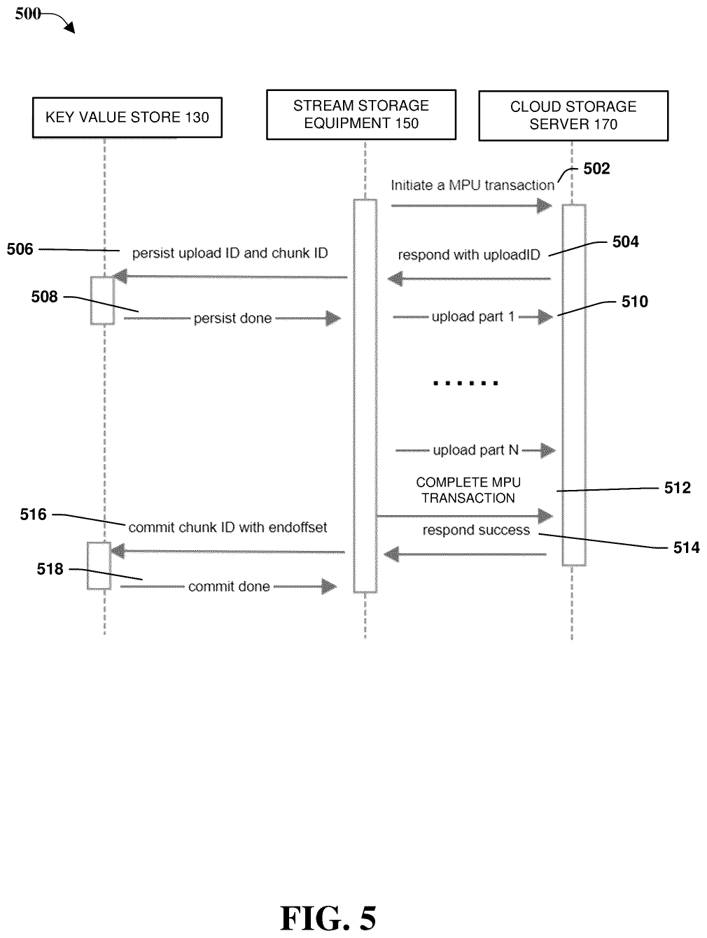

FIG. 5 is a sequence diagram 600 that illustrates example interactions and message exchanges over a period of time between different components of a system that can facilitate using chunks of data to store streaming data at a cloud service provider, in accordance with one or more embodiments. As depicted, key value store 130 exchanges communication with stream storage equipment 150, which exchanges communication with cloud storage server 170.

In one or more embodiments, FIG. 5 depicts an example flow of stream storage equipment creating a data chunk with application data and writing the chunk to cloud storage server 170. In an implementation, stream storage equipment 150 can accept read/write requests from stream applications (e.g., application 185), and can also perform data and metadata update/retrieval tasks.

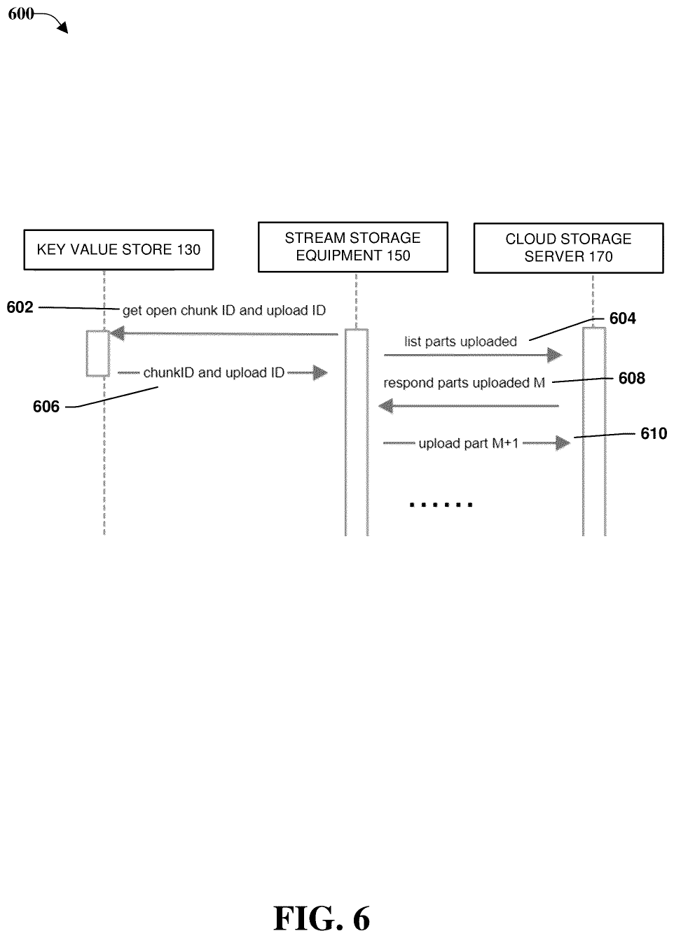

At 502, stream storage equipment 150 first initializes an MPU transaction and gets an upload ID for this transaction from cloud storage server 170. At 506, the stream storage equipment 150 then persists this upload ID of the MPU transaction together with chunk ID to the key value store 130 as metadata. When the persist of the upload ID is done 508, at 510, stream storage equipment 150 uploads one part to the cloud storage server 170 upon each chunk write. Stream storage equipment 150 continues to upload additional parts and, at 512, when the chunk size reaches the maximum limit or a maximum timeout for an open chunk is reached, stream storage equipment 150 completes this MPU transaction with all uploaded parts sequence numbers. At 514, cloud storage server 170 responds to the completion of the MPU with a message indicating success of completion, and at 516, stream storage equipment 150 persists the chunk Id and its end offset in the chunk stream to the key value store 130. At 518, key value store 130 responds that the commit is done. In one or more embodiments, as described with FIG. 6 below, the upload ID persisted in key value store 130 can be used to retrieve the last unfinished transaction during a stream storage equipment 150 failover scenario.

FIG. 6 is a sequence diagram 600 that illustrates example interactions and message exchanges over a period of time between different components of a system that can facilitate using chunks of data to store streaming data at a cloud service provider, in accordance with one or more embodiments.

In one or more embodiments, stream storage equipment 150 can utilize metadata stored in key value store 130 to recover from a crash, and continue writing from the tail of the stream. In an approach to recovery, when stream storage equipment 150 starts up, at 602, from key value store 130, the current open chunk ID can be checked, and its bound upload ID can be retrieved. Next, one or more embodiments of stream storage equipment 150 can retrieve the last upload progress from cloud storage 170, e.g., at 604 a list of all sequence numbers of parts uploaded so far can be returned at 606 with the bound upload ID noted above. In an implementation, to determine the tail of the stored stream, at 608 stream storage equipment 150 can identify the largest number (e.g., M) in the returned list and continue at 610 uploading new parts starting from the last greatest sequence number plus one (e.g., M+1).

One or more embodiments can combine in virtual storage, disparate storage resources maintained by different storage products (e.g., hardware and software storage array products) from different entities (e.g., enterprises, firms, carriers). Benefits that can be realized by integration approaches described herein include, but are not limited to, increased availability, increased security, simultaneous use of multiple product lines maintained by different entities, with less impact for client systems, and improved overall performance.

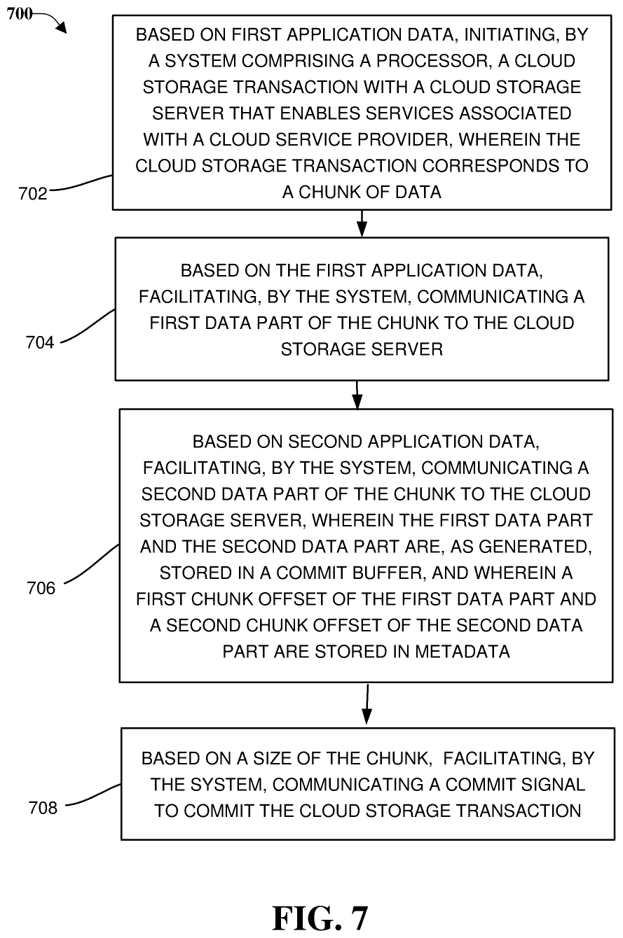

FIG. 7 depicts a flow diagram representing example operations of an example method 700 that can facilitate using chunks of data to store streaming data at a cloud service provider, in accordance with one or more embodiments. For purposes of brevity, description of like elements and/or processes employed in other embodiments is omitted.

In some examples, one or more embodiments of method 700 can be implemented by receiving component 122, communicating component 124, buffering component 126, committing component 128, and other components that can be used to implement aspects of method 700, in accordance with one or more embodiments. It is appreciated that the operating procedures of method 700 are example operating procedures, and that there can be embodiments that implement more or fewer operating procedures than are depicted, or that implement the depicted operating procedures in a different order than as depicted.

At 702 of method 700, receiving component 122 can, in one or more embodiments, based on first application data, initiate a cloud storage transaction with a cloud storage server that can enable services associated with a cloud service provider, with the cloud storage transaction corresponding to a chunk of data, in accordance with one or more embodiments. At 704 of method 700, communicating component 124 can, in one or more embodiments, based on the first application data, facilitate communicating a first data part of the chunk to the cloud storage server, in accordance with one or more embodiments. At 706 of method 700, buffering component 126 can, in one or more embodiments, based on second application data, facilitate communicating a second data part of the chunk to the cloud storage server, with the first data part and the second data part being, as generated, stored in a commit buffer, and with a first chunk offset of the first data part and a second chunk offset of the second data part being stored in metadata, in accordance with one or more embodiments. At 708 of method 700, committing component 128 can, in one or more embodiments, based on a size of the chunk, facilitate communicating a commit signal to commit the cloud storage transaction, in accordance with one or more embodiments.

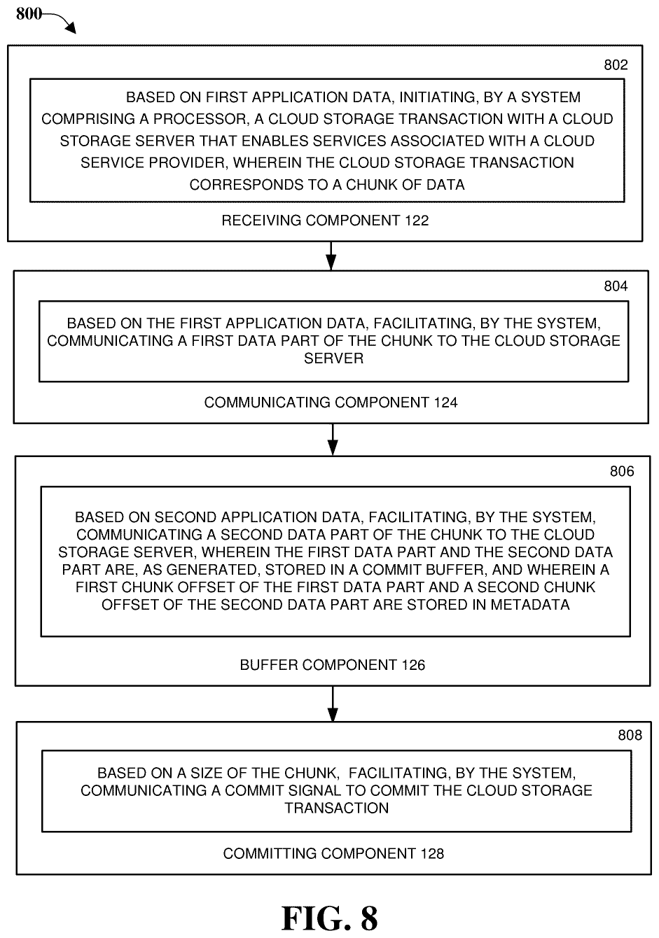

FIG. 8 depicts an example system 800 that can facilitate using chunks of data to store streaming data at a cloud service provider, in accordance with one or more embodiments. For purposes of brevity, description of like elements and/or processes employed in other embodiments is omitted. Example system 800 can include receiving component 122, communicating component 124, buffering component 126, committing component 128, and other components that can be used to implement aspects of system 800, as described herein, in accordance with one or more embodiments.

At 802 of FIG. 8, receiving component 122 can, based on first application data, initiate a cloud storage transaction with a cloud storage server that can enable services associated with a cloud service provider, with the cloud storage transaction corresponding to a chunk of data, in accordance with one or more embodiments. At 804 of FIG. 8, communicating component 124 can, based on the first application data, facilitate communicating a first data part of the chunk to the cloud storage server, in accordance with one or more embodiments. At 806 of FIG. 8, buffering component 126 can, based on second application data, facilitate communicating a second data part of the chunk to the cloud storage server, with the first data part and the second data part being, as generated, stored in a commit buffer, and with a first chunk offset of the first data part and a second chunk offset of the second data part being stored in metadata, in accordance with one or more embodiments. At 806 of FIG. 8, committing component 128 can, based on a size of the chunk, facilitate communicating a commit signal to commit the cloud storage transaction, in accordance with one or more embodiments.

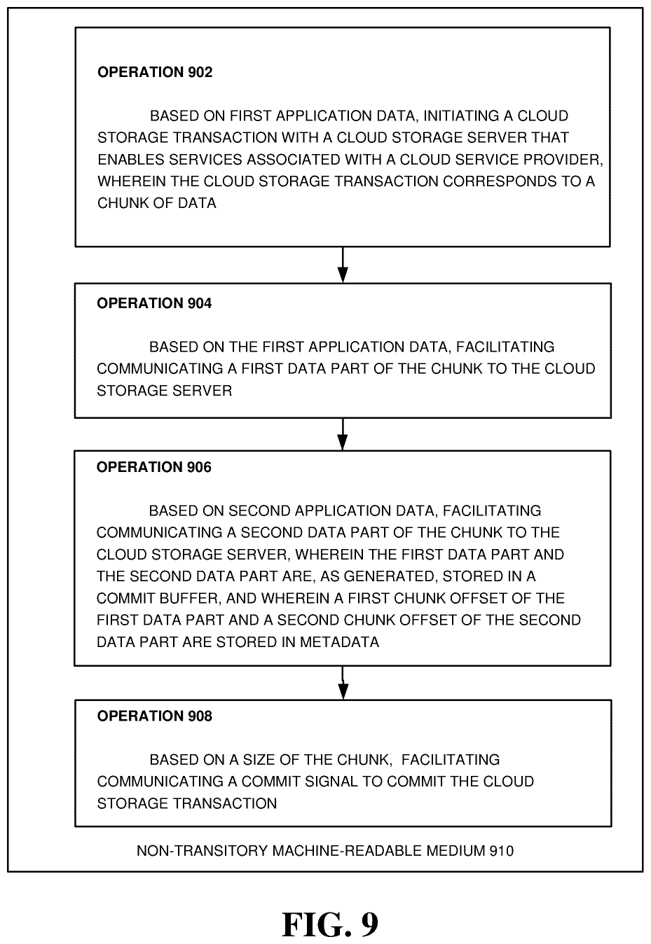

FIG. 9 depicts an example 900 non-transitory machine-readable medium 910 that can include executable instructions that, when executed by a processor of a system, can facilitate using chunks of data to store streaming data at a cloud service provider. For purposes of brevity, description of like elements and/or processes employed in other embodiments is omitted.

Operation 902 of FIG. 9 can facilitate generation of receiving component 122 which, in one or more embodiments, can, based on first application data, initiate a cloud storage transaction with a cloud storage server that can enable services associated with a cloud service provider, with the cloud storage transaction corresponding to a chunk of data. Operation 904 of FIG. 8 can facilitate generation of communicating component 124, which, in one or more embodiments, can, based on the first application data, facilitate communicating a first data part of the chunk to the cloud storage server. Operation 906 of FIG. 8 can facilitate generation of buffering component 126 which, in one or more embodiments can, based on second application data, facilitate communicating a second data part of the chunk to the cloud storage server, with the first data part and the second data part being, as generated, stored in a commit buffer, and with a first chunk offset of the first data part and a second chunk offset of the second data part being stored in metadata. Operation 908 of FIG. 9 can facilitate generation of committing component 128 which, in one or more embodiments can, based on a size of the chunk, facilitate communicating a commit signal to commit the cloud storage transaction.

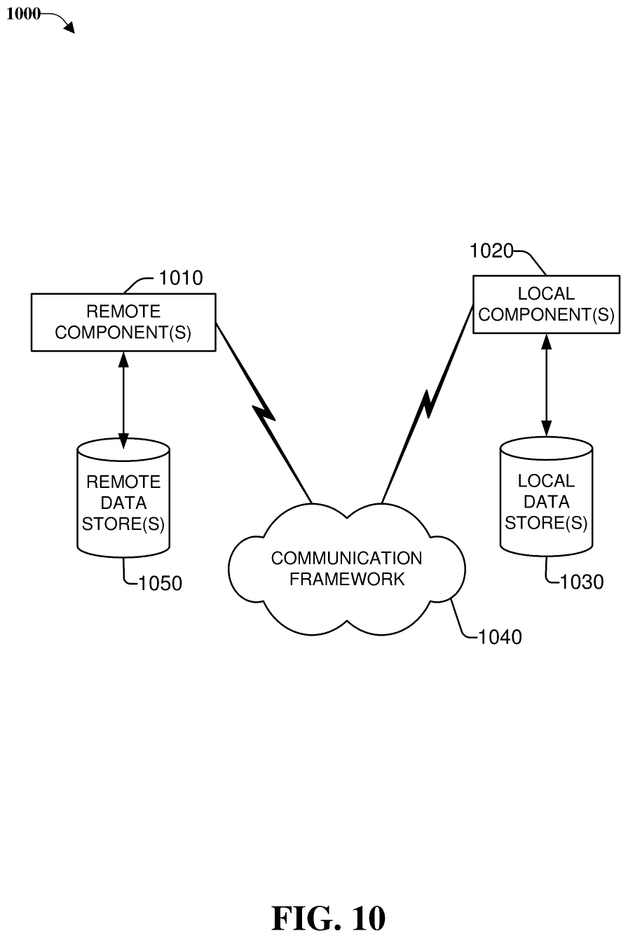

FIG. 10 is a schematic block diagram of a system 1000 with which the disclosed subject matter can interact. The system 1000 comprises one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices).

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store.” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 1030 and remote data store(s) 1050, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random-access memory, double data rate synchronous dynamic random-access memory, enhanced synchronous dynamic random-access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 11, in order to provide additional context for various embodiments described herein, FIG. 11 and the following discussion are intended to provide a brief, general description of a suitable computing environment 1100 in which the various embodiments described herein can be implemented.

While the embodiments have been described above in the general context of computer-executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
based on first application data, initiating, by a system comprising a processor, a cloud storage transaction with a cloud storage server that enables services associated with a cloud service provider, wherein the cloud storage transaction corresponds to a chunk of data;
based on the first application data, facilitating, by the system, communicating a first data part of the chunk to the cloud storage server;
based on second application data, facilitating, by the system, communicating a second data part of the chunk to the cloud storage server, wherein the first data part and the second data part are, as generated, stored in a commit buffer, and wherein a first chunk offset of the first data part and a second chunk offset of the second data part are stored in metadata; and
based on a size of the chunk, facilitating, by the system, communicating a commit signal to commit the cloud storage transaction.

2. The method of claim 1, wherein the commit buffer is comprised in local, volatile storage.

3. The method of claim 1, wherein the commit signal is communicated to result in:
the first data part and the second data part being combined, resulting in combined data parts, and
the combined data parts being stored as a data object in the cloud storage server, resulting in a stored data object.

4. The method of claim 3, further comprising:
after the commit signal is communicated, facilitating, by the system, receiving a request to retrieve the second application data;
based on the metadata:
identifying, by the system, that the stored data object contains the second application data, and
based on the second chunk offset, identifying, by the system, an object offset corresponding to the second application data stored in the stored data object; and
retrieving the second application data from the stored data object, wherein the second application data was identified for retrieval based on the object offset of the second application data.

5. The method of claim 3, wherein the stored data object is immutable.

6. The method of claim 1, wherein the size of the chunk was selected based on a data retrieval constraint of an application that generated the first application data and the second application data.

7. The method of claim 6, wherein the first data part and the second data part are communicated as generated without implicating local non-volatile storage.

8. The method of claim 1, further comprising:
before the commit signal is communicated, facilitating, by the system, receiving a request to retrieve the second application data; and
in response to receiving the request, retrieving, by the system, the second application data from the second data part stored in the commit buffer.

9. The method of claim 1, wherein the first data part and the second data part comprise a stream of application data.

10. Cloud storage equipment, comprising:
at least one processing unit; and
at least one memory coupled to the at least one processing unit and storing instructions configured to be executed by the at least one processing unit, wherein the instructions, when executed by the at least one processing unit, cause the cloud storage equipment to perform actions comprising:
based on a request from stream storage equipment, generating a multipart transaction,
receiving, from the stream storage equipment, a first block of data and a second block of data allocated to the multipart transaction, wherein the stream storage equipment has retained a copy of the first block of data and the second block of data in volatile storage, and
based on an instruction from the stream storage equipment to commit the multipart transaction, aggregating the first block of data and the second block of data into a data object, wherein the stream storage equipment stored, as metadata, offset information describing placement of the first block of data and the second block of data within the data object.

11. The cloud storage equipment of claim 10, wherein the instructions further comprise, additional instructions to perform additional actions comprising:
storing the data object, resulting in a stored data object.

12. The cloud storage equipment of claim 10, wherein the instructions further comprise, additional instructions to perform additional actions comprising:
after the multipart transaction is committed, identifying a data object offset value that corresponds to the second block of data stored in the data object; and
based on the data object offset value, determining a storage location of the second block of data within the data object.

13. The cloud storage equipment of claim 12, wherein identifying the data object offset value comprises:
receiving the metadata stored by the stream storage equipment that implicates the data object offset value; and
based on the metadata, identifying the data object offset value.

14. The cloud storage equipment of claim 13, wherein the first block of data and the second block of data were grouped into a storage group that corresponds to the multipart transaction, and wherein the metadata comprises group offset information that corresponds to group offset data for the first block of data and the second block of data allocated to the multipart transaction.

15. The cloud storage equipment of claim 14, wherein identifying the data object offset value based on the metadata comprises mapping the group offset data corresponding to the second block of data to the data object offset value.

16. The cloud storage equipment of claim 10, wherein the first block of data and the second block of data comprise a stream of application data.

17. A computer program product, tangibly stored on a non-transitory computer-readable medium and comprising machine-executable instructions, wherein the machine-executable instructions, when executed, cause a stream storage device to perform operations, comprising:
receiving a part of a stream linked to a cloud storage transaction with a cloud storage server corresponding to a cloud service provider;
storing, in a part buffer, the part of stream received;
identifying that the cloud storage transaction is not committed, and comprises another part of the stream, other than the part, that was previously included in the cloud storage transaction;
appending the part of stream to an end of the other part of the stream; and
storing metadata comprising an offset value corresponding to an offset of the part of stream, from a beginning of the cloud storage transaction.

18. The computer program product of claim 17, wherein the instructions further comprise, based on a total size of the part of stream and the other part of the stream, committing the cloud storage transaction to be stored via storage equipment corresponding to the cloud service provider.

19. The computer program product of claim 17, wherein the instructions further comprise:
receiving by the system, a request to retrieve the other part of the stream;
responsive to the request, retrieving, by the system, the other part of the stream from the other part stored in the part buffer; and
after the retrieving, sending a commit signal to commit the cloud storage transaction.

20. The computer program product of claim 17, wherein the part buffer is comprised in volatile storage that is local to the stream storage device.
